(19) United States
(12) Patent Application Publication
(10) Pub. No.: US 2006/0265243 A1
(43) Pub. Date: Nov. 23, 2006

(54) System and method for establishing or verifying a person's identity using SMS and MMS over a wireless communications network

(76) Inventors: Jeffrey Racho, Conshohocken, PA (US); Moneet Singh, Conshohocken, PA (US); Neeraj Bansal, Philadelphia, PA (US)

Correspondence Address: Jeffrey Racho, Esq.;Ste. 200, 219 Righters Mill, Narberth, PA, 19072, US

(21) Appl. No.: 11/433,970

(22) Filed: May 15, 2006

Related U.S. Application Data
(60) Provisional application No. 60/682,943, filed on May 20, 2005.

(51) Int. Cl. G06Q 99/00

(52) U.S. Cl. 705/1

(57) ABSTRACT

Individuals asked to present two forms of picture identification face a problem as individuals usually only have one form of picture ID, that form of identification generally being a state-issued driver's license. The disclosed invention is a system and method for a party, generally a Customer or Patron, to establish proof of identification to another party, generally a Merchant or Agent, via a mobile phone using the mobile communications networks. The invention thereby provides the Merchant or Agent with an additional capability to verify the identity of Customers, including verification of the date of birth of the Customer. In a preferred embodiment, the invention uses the Short Message Service (“SMS”) and Multimedia Messaging Service (“MMS”) features available on mobile phones, or other wireless communication devices, to establish the identity of a Customer after communicating a request for such identification to a government administered identification database system.

### CROSS REFERENCE TO RELATED APPLICATIONS

This nonprovisional patent application claims the benefit of the filing date of provisional application 60/682,943, filed May 20, 2005, which is herein incorporated by reference.

### STATEMENT REGARDING FEDERALLY SPONSORED RESEARCH AND DEVELOPMENT

No Federally sponsored research or development was requested for, accepted, or used in the development related to the invention herein claimed.

### BACKGROUND OF THE INVENTION

Individuals asked to present two forms of picture identification sometimes face a problem since the individual may only have one form of picture ID, that form of identification generally being a driver's license. Many individuals may own a passport but fail to have the passport on their person if they are challenged for two forms of picture ID at a domestic location. Although some individuals have credit cards embossed with a photograph, it is possible that a significant portion of consumers may lack either a passport or an additional form of picture ID.

Some state agencies, such as state Departments of Transportation (“DOTs”), use electronic methods of issuing forms of state identification, such as driver's licenses. State approved photo centers for issuing such forms of identification are equipped to take a digital photograph of the subject, insert the photo into a digital identification card or driver's license (which may be a scan of a temporary driver's card), and then print the finalized identification or license. The photo centers may be networked into a state agency or DOT computer system so that information can be shared among the various photo centers. As an example, some photo centers may be able to issue duplicate driver's licenses by retrieving a digital version of the license (including the picture of the subject/licensee) from the DOT network and printing the license. The photographs of the subjects/licensees are stored on the network in the form of a digital file.

The general availability of two forms of picture identification may also help to reduce the effects of identification fraud. Identification fraud is a concern of state governments in that false identification may be used to purchase alcohol, tobacco or firearms. The procurement of false identification may take two forms: (1) fraudulently obtaining a birth certificate, which is then used to obtain a false driver's license or other form of identification from a state agency or DOT; or (2) obtaining a false form of identification, such as a driver's license, from a forger. A simple system allowing merchants or agents to verify the identity of customers or patrons presenting questionable forms of identification could be used to reduce the use of false identification to purchase goods such as alcohol, tobacco or firearms.

### BRIEF SUMMARY OF THE INVENTION

The claimed invention is a system and method for a party, generally a Customer or Patron, to establish proof of identification to another party, generally a Merchant or Agent, via a mobile phone using the mobile communications networks, thereby allowing the Merchant or Agent to verify the identity of Customers or Patrons who either have no identification or who present forms of identification of questionable authenticity. The proposed system and method allows Merchants or Agents to verify from the proper state agency (such as a DOT) that the Customer or Patron presenting the identification is indeed the person depicted on the identification, and that he/she was indeed born on the date listed on any presented identification.

The system embodying the disclosed method may take the form of using various electronic devices to facilitate electronic communications between the Customer and the Merchant. In a preferred embodiment, the Short Message Service (“SMS”) and Multimedia Messaging Service (“MMS”) features available on mobile or cellular phones, or other forms of wireless communication, are used to establish the identity of a Customer after communicating a request for such identification to a government administered identification database system.

### BRIEF DESCRIPTION OF THE DRAWINGS

FIG. 1 depicts the invention being used in a manner in which the Customer or Patron initiates the identification query after being challenged by the Merchant or Agent. FIG. 2 depicts the invention being used in a manner in which the Merchant or Agent initiates the identification query after challenging the Customer or Patron. FIG. 3 depicts a variant of FIG. 1 in which the claimed invention is operated directly by a government agency. FIG. 4 depicts a variant of FIG. 2 in which the claimed invention is operated directly by a government agency. FIG. 5 depicts a variant of FIG. 1 in which the claimed invention is operated solely by a trusted third party. FIG. 6 depicts a variant of FIG. 2 in which the claimed invention is operated solely by a trusted third party.

### DETAILED DESCRIPTION OF THE INVENTION

The system (“System”) implementing the disclosed method of the invention comprises a plurality of computers, including web servers and database servers, routers, electronic communications devices, and software programs designed to implement the methods and processes described below. The System will also include a database of registered users (the “System User Database”) who have registered on the System so that they may use the invention. The System may be scalable to meet the operating entity's needs as required. A person skilled in the arts of computer technology may make the System using typical “off-the-shelf” components including routers, servers and electronic components available from any of a number of computer hardware manufacturers. A person skilled in the arts of information technology, including database administration and Internet and other communications protocols, may develop software programs implementing the methods and processes claimed herein from any number of computer languages, such as Perl or PHP, running on any number of computer operating systems, such as Linux. Such software programs will embody the processes described herein and operate on the System.

There are two options for the administration of the System: it may be administered by a Trusted Third Party (“TTP”) entity, or it may be administered by a government agency, such as a DOT. In the former embodiment, the TTP has reached an agreement or contract with the government entity which administers a state-approved or state-managed identification database system, such as a DOT. Privacy concerns and electronic security concerns may dictate which option may be chosen for states which choose to implement the system and method.

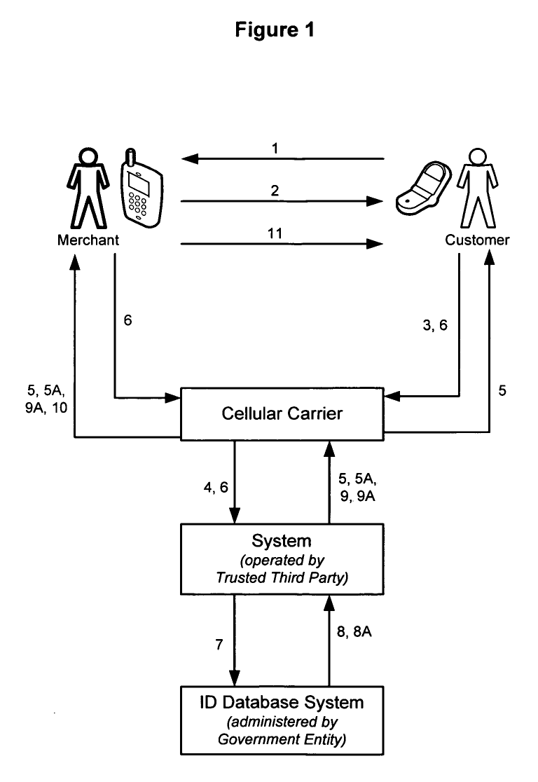

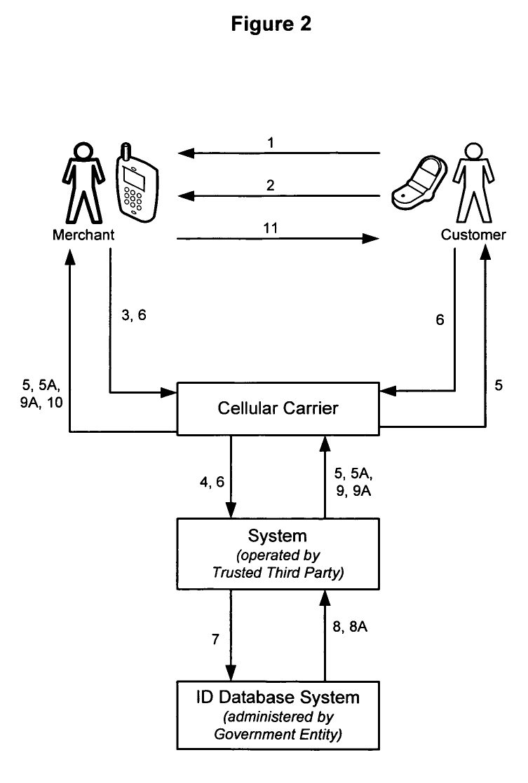

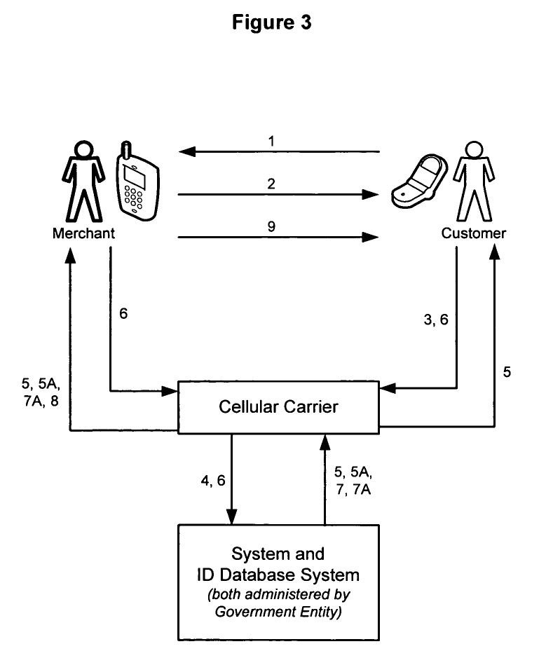

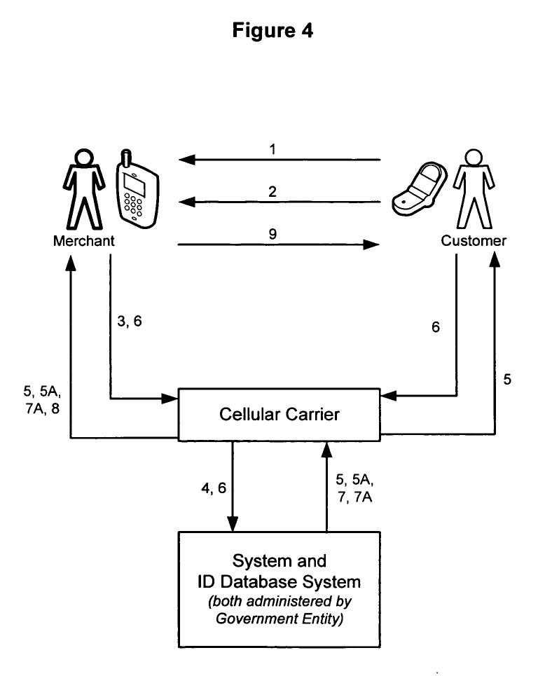

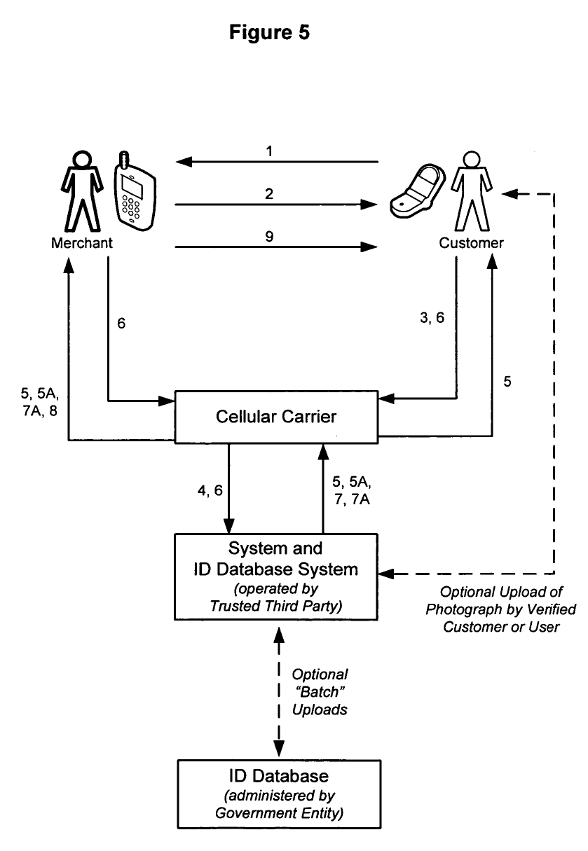

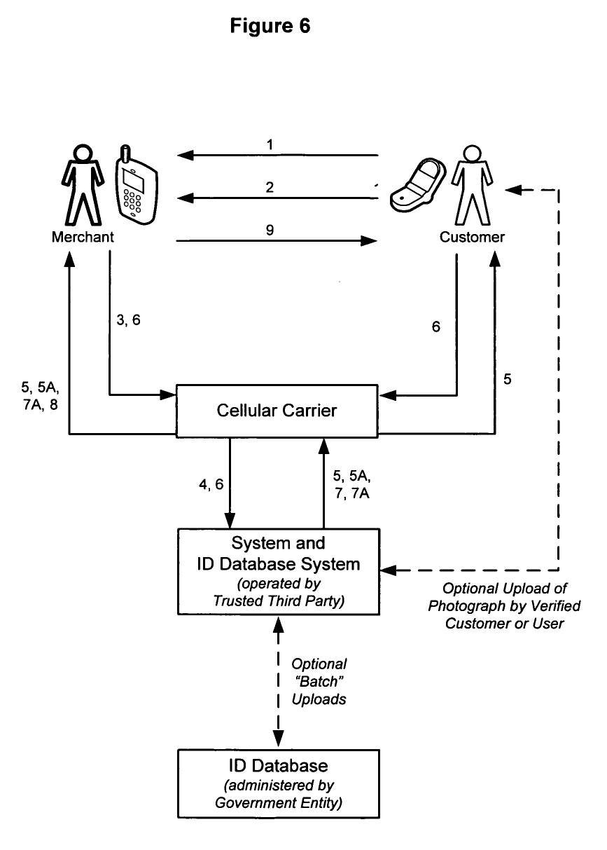

The embodiments in which the System is operated by a TTP are presented in FIGS. 1, 2, 5 and 6. A preferred embodiment of the invention is that depicted in FIG. 1. The alternatives in which the System is operated by a government entity, such as the DOT itself, are displayed in FIGS. 3 and 4. In another embodiment of the invention, the TTP may itself accept photographs of users uploaded to the TTP's computer systems by users whose identity has been verified by the TTP in some manner. FIGS. 5 and 6 present two variants of this embodiment.

FIG. 1 presents the first embodiment of the invention in which the query for the Customer's identification is submitted by the Customer.

For this description of the process and method described in FIG. 1, a TTP shall administer and operate the System. The TTP will interface its System with an identification database system (“ID Database System”) operated by the appropriate government agency, such as a Department of Transportation. The ID Database System stores the digital pictures of the state's licensed drivers, which were taken at the state's photo identification centers, and also stores other relevant information, such as the licensees' dates of birth (“DOB”), the licensees' names, addresses, etc. This data may be stored in the ID Database System under a primary key equal to the driver number or license number which appears on driver's licenses.

Note that in another implementation of the claimed invention the government entity itself may administer the System, integrating it with the ID Database System. This embodiment of the Invention is described below and presented in two variants in FIGS. 3 and 4.

It shall be a requirement that Customers who wish to use the claimed invention as a form of ID verification set up accounts in the System User Database via the Internet or some other form of electronic communication. The Customers will need to provide the System User Database with the phone numbers of their mobile phones; in the alternative, when accessing their accounts on the System, the Customers may create a user identification name (“User ID”) to be associated with their personally identifiable information, including the phone number of their mobile phones. The Customers will also need to provide other information to the System User Database, such as their driver license number or identification number on their state-issued ID card. By submitting this information, the System now has a set of data which it can use to cross-check against the driver's data on the ID Database System.

The System may also be configured so that Merchants who desire to use the system must also create accounts in the System User Database prior to using it in order to reduce the likelihood of fraud or abuse of the System by nonregistered parties.

In Step 1 of FIG. 1, a Customer approaches a Merchant and attempts to purchase goods such as alcohol or cigarettes, or attempts entry into an establishment restricted by age, such as an alcohol-serving business or a casino. The Customer has set up an account on the System and has on their person a mobile phone capable of communicating with the System, such as by sending SMS messages (although other forms of electronic communication, such as a phone call to an automated phone line or email, are possible). When the Customer attempts to purchase the good or obtain entry, the Merchant will challenge the Customer to produce identification. If the Customer either (1) does not have their driver license, or (2) presents their license, which the Merchant does not believe to be valid, the Merchant will then challenge the Customer to produce further identification verifying their age and identity.

In Step 2 of FIG. 1, the Merchant has on their person a mobile phone capable of receiving MMS messages. The Merchant will then give their mobile phone number or his/her User ID to the Customer. The Merchant's User ID must be created by the Merchant during an account set-up procedure on the System; the invention, however, may still be configured to operate even if the Merchant has not created an account on the System.

In Step 3 of FIG. 1, the Customer will then send a SMS message (the “SMS Request Message”) addressed to the System by way of a cellular carrier, requesting that the System remit the Customer's identification to the mobile phone owned by the Merchant (the SMS Request Message may also take other forms of electronic communication, such as a phone call to an automated phone line or email). The SMS Request Message will include the Merchant's mobile phone number or the Merchant's User ID and may take a form such as “Show ID to Merchant123” or “Show ID to 215-555-1234.” The TTP may also choose to have such requests delivered to a specially identified SMS short code address, email address, or phone number for “branding” purposes.

In Step 4 of FIG. 1, the SMS Request Message (or other form of electronic communication) is delivered to the System operated by the Cellular Carrier.

In Step 5 of FIG. 1, the System checks the identity of the mobile phone sending the SMS Request Message against the System User Database to match the phone number of the sending mobile phone with the phone number associated with the account created by the Customer. The System extracts the Merchant's mobile phone number or User ID from the SMS Request message; if the Merchant's User ID has been submitted, the System will obtain the Merchant's mobile phone number by checking the User ID against the User IDs in the System User Database, thereupon obtaining the mobile phone number associated with the User ID (the Merchant's use of a User ID would require the Merchant to have registered an account on the System). The System then sends an SMS to the Merchant's mobile phone asking the Merchant to verify that it wants to identify the Customer (the “Merchant SMS Verification Message”). The Merchant SMS Verification Message is delivered from the System to a Carrier, thereupon to the Merchant. The System may optionally send an SMS to Customer, asking the Customer to confirm that he/she wishes to remit his/her identification to the Merchant (the “Customer SMS Verification Message”). The System may optionally be configured to accept requests from registered Merchants only; should the System fail to locate the Merchant's mobile number or User ID in the System User Database, the System will terminate the procedure, and remit failure notices to the Merchant and Customer akin to the failure notice of Step 5A.

The Merchant SMS Verification Message may take the form “Receive ID Verification?” with an optional alphanumeric personal identification number (“PIN”) included in the Merchant SMS Verification Message. If the Merchant has registered with the System, it has already created a PIN on the System. After receiving the SMS Request Message and extracting the Merchant's mobile phone number (or obtaining the mobile phone number after checking the submitted User ID against the User IDs in the System User Database), the System will retrieve the Merchant's PIN from the System User Database and append the PIN to the Merchant SMS Verification Message. This process allows the Merchant to verify that the Merchant SMS Verification Message is authentic and has indeed been sent by the System because only the Merchant and the System will know the PIN created by the Merchant during his/her account set-up. Likewise, the Customer SMS Verification Message may take the form of “Remit your ID to Merchant123?” with the Customer's PIN (again, created by the Customer when he/she created an account on the System) appended to the Customer Verification Message so that the Customer can verify the authenticity of the Customer Verification Message.

In Step 5A of FIG. 1, if the System cannot match the phone number of the mobile phone sending the SMS Request Message against the phone numbers in the System User Database, the System sends an SMS to the Merchant's mobile phone notifying the Merchant that it cannot confirm the ID of the Customer (the “SMS Denial Message”). The SMS Denial Message is delivered from the System to a Carrier, thereupon to the Merchant. The process ends and the Merchant may refuse service to the Customer.

In Step 6 of FIG. 1, the Merchant, after verifying the optional PIN in the Merchant SMS Verification Message is correct, will then reply to the Merchant SMS Verification Message with an SMS message to the System, affirming the desire to receive the ID verification MMS message (the “Merchant SMS Affirmation Message”). The Merchant SMS Verification Message is routed through a Carrier and delivered to the System. The Customer will also reply to the Customer SMS Verification Message with an SMS message affirming his/her desire to have his/her ID submitted to the Merchant (the “Customer SMS Affirmation Message”). The System must receive both the Merchant SMS Affirmation Message and the Customer SMS Affirmation Message before the process may continue. If the System fails to receive both SMS Affirmation Messages (or only the Merchant SMS Affirmation Message if the Customer SMS Confirmation Message step has been omitted), then the System halts the process.

Note that, in some forms of the first embodiment, the SMS Verification Messages and SMS Affirmation Messages of Steps 5 and 6 may be eliminated if a lesser degree of security, but a higher degree of ease of use, is desired.

In Step 7 of FIG. 1, if the System, as described in Step 5, has verified the identity of the mobile phone sending the SMS Request Message against the System User Database and successfully matched the User ID or phone number with the account created by the Customer, then the System submits an ID request (“ID Request”) for Customer's identification to the ID Database System administered by the government agency. The ID Request may take the form of sending the Customer's driver license number, which was submitted to the System upon Customer's registration with the System.

In Step 8 of FIG. 1, after receiving the ID Request, the ID Database System queries its data records for the Customer's identification data and retrieves a digital image of Customer, and optionally other data such as a date of birth (“DOB”) and the Customer's name. The ID Database System then submits the digital image, DOB and any other data to the System via an electronic message (“ID Data Reply”).

In Step 8A of FIG. 1, if the ID Database System, after receiving the ID Request, cannot match the data submitted in the ID Request (such as the Customer's driver license number) to its stored data, the ID Database System sends a message to the System indicating the failure to achieve a match (“ID Failure Message”).

In Step 9 of FIG. 1, the System receives the ID Data Reply which was sent as described in Step 8. The System then composes an MMS message including the digital image and the DOB of Customer and any other optional data included in the ID Data Reply. The System can also include in the MMS message a warning if the Customer is below the age of eighteen or twenty-one. The System then addresses the MMS message to the Merchant's mobile phone and delivers the MMS message to the Cellular Carrier.

In Step 9A of FIG. 1, if the System receives an ID Failure Message, the System sends an SMS notifying the Merchant that it cannot confirm the ID of the Customer (“SMS Denial Message”). The SMS Denial Message is delivered from the System to a Carrier, thereupon to the Merchant. The process ends and the Merchant may refuse service to the Customer.

In Step 10 of FIG. 1, the Cellular Carrier delivers the MMS message from Step 9 to Merchant's mobile phone. Merchant can now view the digital image of the customer, and the optional DOB (and other optional data) on the mobile phone.

In Step 11 of FIG. 1, after viewing the MMS message, Merchant can confirm the identity and the age of Customer. If the identity of the Customer has been confirmed, the Merchant may sell the goods to the Customer, deliver services to the Customer, allow the Customer into Merchant's restricted premises, etc.

FIG. 2 presents the second embodiment of the invention in which the query for the Customer's identification is made by the Merchant.

In the second embodiment presented in FIG. 2, a TTP shall administer and operate the System. The System, however, may be administered by a government agency and integrated with the ID Database System; this alternate embodiment of the claimed invention is presented in FIG. 4.

Step 1 of the second embodiment is equivalent to Step 1 of the first embodiment, above.

In Step 2 of the second embodiment, instead of the Merchant giving its mobile phone number or email address to the Customer, the Customer gives its mobile phone number or User ID (as created by the Customer during his/her account set-up procedure on the System) to the Merchant.

In Step 3 of the second embodiment, the Merchant will then send a SMS message (“SMS Request Message”) addressed to the System by way of a cellular carrier, requesting that the System remit the Customer's identification to the mobile phone owned by the Merchant (the SMS Request Message may also take other forms of electronic communication, such as a phone call to an automated phone line or email). The SMS Request Message will contain the Customer's mobile phone number or User ID and may take a form such as “Request ID for AnyUser123” or “Request ID for 215-555-1234.” The System may also choose to have such requests delivered to a specially identified SMS short code address, email address, or phone number for “branding” purposes.

Step 4 of the second embodiment is equivalent to Step 4 of the first embodiment, above.

In Step 5 of the second embodiment, the System may optionally check the Merchant's mobile phone number against the mobile phone numbers of registered users in the System User Database and refuse the identification request if the Merchant is not registered. The System then extracts the Customer's mobile phone number or User ID from the SMS Request message and checks for a match in the System User Database. If the Customer's User ID has been submitted, the System will obtain the Customer's mobile phone number by checking the Customer's User ID against the User IDs in the System User Database, thereupon obtaining the mobile phone number associated with the User ID.

The System then sends an SMS to the Customer's mobile phone asking the Customer to verify that he/she wants to identify himself/herself to the Merchant (the “Customer SMS Verification Message”). The Customer SMS Verification Message is delivered from the System to a Carrier, thereupon to the Customer. The System may optionally send an SMS to the Merchant, asking the Merchant to confirm that he/she wishes to identify the Customer (the “Merchant SMS Verification Message”). The System may optionally be configured to accept requests from registered Merchants only; should the System fail to locate the Merchant's mobile number or User ID in the System User Database, the System will terminate the procedure, and remit failure notices to the Merchant and Customer akin to the failure notice of Step 5A.

The Customer SMS Verification Message may take the form “Deliver your ID to Merchant123?” with an optional alphanumeric personal identification number (“PIN”) included in the Customer SMS Verification Message. As the Customer has registered with the System, he/she has already created a PIN on the System. After receiving the SMS Request Message and extracting the Customer's mobile phone number (or obtaining the mobile phone number after checking the submitted User ID against the User IDs in the System User Database), the System will retrieve the Customer's PIN from the System User Database and append the PIN to the Customer SMS Verification Message. This process allows the Customer to verify that the Customer SMS Verification Message is authentic and has indeed been sent by the System because only the Customer and the System will know the PIN created by the Customer during his/her account set-up. Likewise, the Merchant SMS Verification Message may take the form of “Receive ID from AnyUser123?” with the Merchant's PIN (again, created by the Merchant during the account set-up on on the System) appended to the Merchant SMS Verification Message so that the Merchant can verify the authenticity of the Merchant SMS Verification Message.

In Step 5A of the second embodiment, if the System cannot locate either the Customer's ID or the Customer's mobile phone number in the System User Database, it remits a failure notification to the Merchant indicating that that it cannot confirm the identity of the Customer (the “SMS Denial Message”). The SMS Denial Message is delivered from the System to a Carrier, thereupon to the Merchant. The process ends and the Merchant may refuse service to the Customer

In Step 6 of the second embodiment, the Customer, after verifying the optional PIN in the Customer SMS Verification Message is correct, will then reply to the Customer SMS Verification Message with an SMS message to the System, manifesting his/her assent to the System remitting his/her identification to the Merchant (the “Customer SMS Affirmation Message”). The Customer SMS Verification Message is routed through a Carrier and delivered to the System. The Merchant will also reply to the Merchant SMS Verification Message with an SMS message affirming its desire to receive the Customer's identification (the “Merchant SMS Affirmation Message”). The System must receive both the Merchant SMS Affirmation Message and the Customer SMS Affirmation Message before the process may continue. If the System fails to receive both SMS Affirmation Messages (or only the Customer SMS Affirmation Message if the Merchant SMS Confirmation Message step has been omitted), then the System halts the process.

Note that, in some forms of the second embodiment, the SMS Verification Messages and SMS Affirmation Messages of Steps 5 and 6 may be eliminated if a lesser degree of security, but a higher degree of ease of use, is desired.

In Step 7 of the second embodiment, if the System, has optionally verified the identity of the Merchant's mobile phone (which sent the SMS Request Message) against the System User Database and successfully matched the Customer's User ID or phone number with the account created by the Customer, then the System submits an ID request (“ID Request”) for Customer's identification to the ID Database System administered by the government agency. The ID Request may take the form of sending the Customer's driver license number, which was submitted to the System upon Customer's registration with the System.

Step 8 of the second embodiment is equivalent to Step 8 of the first embodiment, above.

Step 8A of the second embodiment is equivalent to Step 8A of the first embodiment, above.

Step 9 of the second embodiment is equivalent to Step 9 of the first embodiment, above.

Step 9A of the second embodiment is equivalent to Step 9A of the first embodiment, above.

Step 10 of the second embodiment is equivalent to Step 10 of the first embodiment, above.

Step 11 of the second embodiment is equivalent to Step 11 of the first embodiment, above.

FIG. 3 presents the third embodiment of the invention in which the query for the Customer's identification is made by the Customer to a System administered by a government entity instead of a TTP as described in the first and second embodiments.

Step 1 of the third embodiment is equivalent to Step 1 of the first embodiment, above.

Step 2 of the third embodiment is equivalent to Step 2 of the first embodiment, above.

Step 3 of the third embodiment is equivalent to Step 3 of the first embodiment, above, excepting that the Customer's SMS Request Message is delivered to a System operated and administered by a government entity.

Step 4 of the third embodiment is equivalent to Step 4 of the first embodiment, above, excepting that the SMS Request Message (or other form of electronic communication) is delivered to a System operated and administered by a government entity.

Step 5 of the third embodiment is equivalent to Step 5 of the first embodiment, above, excepting that the System is operated and administered by a government entity.

Step 5A of the third embodiment is equivalent to Step 5A of the first embodiment, above.

Step 6 of the third embodiment is equivalent to Step 6 of the first embodiment, above, excepting that the System is operated and administered by a government entity.

Note that, in some forms of the third embodiment, the SMS Verification Messages and SMS Affirmation Messages of Steps 5 and 6 may be eliminated if a lesser degree of security, but a higher degree of ease of use, is desired.

In Step 7 of the third embodiment, after receiving the SMS Request Message and the optional SMS Affirmation Messages, the System queries the data records of the government entity's ID Database System for the Customer's identification data and retrieves a digital image of Customer, and optionally other data such as a date of birth (“DOB”), as stored in the database. The System then composes an MMS message including the digital image and the DOB of Customer and any other optional data, including a warning if the Customer is below the age of eighteen or twenty-one. The System of the government entity then addresses the MMS message to Merchant's mobile phone and delivers the MMS message to a Cellular Carrier.

In Step 7A of the third embodiment, if the System's query to the government entity's ID Database System of Step 7 yielded no data record for the Customer then the System sends an ID Failure Message via SMS to the Cellular Carrier, and thereupon to the Merchant, indicating the failure to achieve a match.

In Step 8 of the third embodiment, the Cellular Carrier delivers the MMS message created in Step 7 to the Merchant's mobile phone. The Merchant can now view the digital image of the customer, and the optional DOB (and other optional data) on the mobile phone.

Step 9 of the third embodiment is equivalent to Step 11 of the first embodiment, above.

FIG. 4 presents the fourth embodiment of the invention in which the query for the Customer's identification is made by the Merchant to a System administered by a government entity instead of a TTP as described in the first and second embodiments.

Step 1 of the fourth embodiment is equivalent to Step 1 of the second embodiment, above.

Step 2 of the fourth embodiment is equivalent to Step 2 of the second embodiment, above.

Step 3 of the fourth embodiment is equivalent to Step 3 of the second embodiment, above.

Step 4 of the fourth embodiment is equivalent to Step 4 of the second embodiment, above, excepting that the SMS Request Message (or other form of electronic communication) is delivered to a System operated and administered by a government entity.

Step 5 of the fourth embodiment is equivalent to Step 5 of the second embodiment, above, excepting that the System is operated and administered by a government entity.

Step 5A of the fourth embodiment is equivalent to Step 5A of the second embodiment, above.

Step 6 of the fourth embodiment is equivalent to Step 6 of the second embodiment, above, excepting that the System is operated and administered by a government entity.

Note that, in some forms of the third embodiment, the SMS Verification Messages and SMS Affirmation Messages of Steps 5 and 6 may be eliminated if a lesser degree of security, but a higher degree of ease of use, is desired.

In Step 7 of the fourth embodiment, after receiving the SMS Request Message and the optional SMS Affirmation Messages, the System queries the data records of the government entity's ID Database System for the Customer's identification data and retrieves a digital image of Customer, and optionally other data such as a date of birth (“DOB”), as stored in the database. The System then composes an MMS message including the digital image and the DOB of Customer and any other optional data, including a warning if the Customer is below the age of eighteen or twenty-one. The System of the government entity then addresses the MMS message to Merchant's mobile phone and delivers the MMS message to a Cellular Carrier.

In Step 7A of the third embodiment, if the System's query to the government entity's ID Database System of Step 7 yielded no data record for the Customer then the System sends an ID Failure Message via SMS to the Cellular Carrier, and thereupon to the Merchant, indicating the failure to achieve a match.

In Step 8 of the third embodiment, the Cellular Carrier delivers the MMS message created in Step 7 to the Merchant's mobile phone. The Merchant can now view the digital image of the customer, and the optional DOB (and other optional data) on the mobile phone.

Step 9 of the fourth embodiment is equivalent to Step 11 of the second embodiment, above.

FIG. 5 presents the fifth embodiment of the invention in which the query for the Customer's identification is made by the Customer to a System administered by a TTP. In this embodiment, the TTP also administers the ID Database System, which may be uploaded to the TTP by a “batch” process from a database administered by a government entity, such as a DOT. In the alternative, the digital photographs in the ID Database System may be uploaded by Customers and users whose identities have been verified in some manner by the TTP. Both options are illustrated in FIG. 5.

Step 1 of the fifth embodiment is equivalent to Step 1 of the first embodiment, above.

Step 2 of the fifth embodiment is equivalent to Step 2 of the first embodiment, above.

Step 3 of the fifth embodiment is equivalent to Step 3 of the first embodiment, above.

Step 4 of the fifth embodiment is equivalent to Step 4 of the first embodiment, above.

Step 5 of the fifth embodiment is equivalent to Step 5 of the first embodiment, above.

Step 5A of the fifth embodiment is equivalent to Step 5A of the first embodiment, above.

Step 6 of the fifth embodiment is equivalent to Step 6 of the first embodiment, above.

Note that, in some forms of the third embodiment, the SMS Verification Messages and SMS Affirmation Messages of Steps 5 and 6 may be eliminated if a lesser degree of security, but a higher degree of ease of use, is desired.

In Step 7 of the fifth embodiment, after receiving the SMS Request Message and the optional SMS Affirmation Messages, the System queries the data records of the ID Database System (operated and administered by the TTP) for the Customer's identification data and retrieves a digital image of Customer, and optionally other data such as a date of birth (“DOB”), as stored in the database. The System then composes an MMS message including the digital image and the DOB of Customer and any other optional data, including a warning if the Customer is below the age of eighteen or twenty-one. The System of the government entity then addresses the MMS message to Merchant's mobile phone and delivers the MMS message to a Cellular Carrier.

In Step 7A of the fifth embodiment, if the System's query to the ID Database System of Step 7 yielded no data record for the Customer then the System sends an ID Failure Message via SMS to the Cellular Carrier, and thereupon to the Merchant, indicating the failure to achieve a match.

In Step 8 of the fifth embodiment, the Cellular Carrier delivers the MMS message created in Step 7 to the Merchant's mobile phone. The Merchant can now view the digital image of the customer, and the optional DOB (and other optional data) on the mobile phone.

Step 9 of the fifth embodiment is equivalent to Step 11 of the first embodiment, above.

FIG. 6 presents the sixth embodiment of the invention in which the query for the Customer's identification is made by the Merchant to a System administered by a TTP. In this embodiment, the TTP also administers the ID Database System, which may be uploaded to the TTP by a “batch” process from a database administered by a government entity, such as a DOT. In the alternative, the digital photographs in the ID Database System may be uploaded by Customers and users whose identities have been verified in some manner by the TTP. Both options are illustrated in FIG. 5.

Step 1 of the sixth embodiment is equivalent to Step 1 of the second embodiment, above.

Step 2 of the sixth embodiment is equivalent to Step 2 of the second embodiment, above.

Step 3 of the sixth embodiment is equivalent to Step 3 of the second embodiment, above.

Step 4 of the sixth embodiment is equivalent to Step 4 of the second embodiment, above.

Step 5 of the sixth embodiment is equivalent to Step 5 of the second embodiment, above, excepting that the System is operated and administered by a government entity.

Step 5A of the sixth embodiment is equivalent to Step 5A of the second embodiment, above.

Step 6 of the sixth embodiment is equivalent to Step 6 of the second embodiment, above.

Note that, in some forms of the third embodiment, the SMS Verification Messages and SMS Affirmation Messages of Steps 5 and 6 may be eliminated if a lesser degree of security, but a higher degree of ease of use, is desired.

In Step 7 of the sixth embodiment, after receiving the SMS Request Message and the optional SMS Affirmation Messages, the System queries the data records of the ID Database System (operated and administered by the TTP) for the Customer's identification data and retrieves a digital image of Customer, and optionally other data such as a date of birth (“DOB”), as stored in the database. The System then composes an MMS message including the digital image and the DOB of Customer and any other optional data, including a warning if the Customer is below the age of eighteen or twenty-one. The System of the government entity then addresses the MMS message to Merchant's mobile phone and delivers the MMS message to a Cellular Carrier.

In Step 7A of the sixth embodiment, if the System's query to the ID Database System of Step 7 yielded no data record for the Customer then the System sends an ID Failure Message via SMS to the Cellular Carrier, and thereupon to the Merchant, indicating the failure to achieve a match.

In Step 8 of the sixth embodiment, the Cellular Carrier delivers the MMS message created in Step 7 to the Merchant's mobile phone. The Merchant can now view the digital image of the customer, and the optional DOB (and other optional data) on the mobile phone.

Step 9 of the sixth embodiment is equivalent to Step 11 of the second embodiment, above

I claim:

1. A method whereby a Non-identified Party may establish his or her identity to an Identifying Party, comprising the steps of:
said Identifying Party requesting that said Non-identified Party produce a form of picture identification;
said Identifying Party remitting to said Non-identified Party either a phone number associated with a mobile phone belonging to said Identifying Party or a user identification name belonging to said Identifying Party, said user identification name belonging to said Identifying Party having been created by said Identifying Party on a computer system administered by a Trusted Third Party;
said Non-identified Party electronically remitting to said computer system an identity request message sent from a mobile phone belonging to said Non-identified Party, said identity request message including either said phone number associated with a mobile phone belonging to said Identifying Party or said user identification name belonging to said Identifying Party, said Non-identified Party having created a Non-identified Party data record in a system user database administered by said computer system, said data record comprising personally identifiable information pertaining to said Non-identified Party;
said computer system receiving said identity request message;
said computer system extracting either said phone number associated with said mobile phone belonging to said Identifying Party or said user identification name belonging to said Identifying Party from said identity request message;
said computer system, should said identity request message include said user identification name belonging to said Identifying Party but not said phone number associated with said mobile phone belonging to said Identifying Party, upon locating said data record created by said Identifying Party, retrieving said phone number associated with said mobile phone belonging to said Identifying Party from said data record created by said Identifying Party;
said computer system processing said user identification name belonging to said Identifying Party or said phone number associated with said mobile phone belonging to said Identifying Party against said system user database to verify that said Identifying Party has created a data record in said system user database, said computer system terminating the method at this step should said computer system fail to locate said data record created by said Identifying Party, thereupon said computer system remitting a first failure message to said mobile phone belonging to said Non-identified Party;
said computer system extracting information identifying said mobile phone belonging to said Non-identified Party from said identity request message, thereupon said computer system processing said extracted information identifying said mobile phone belonging to said Non-identified Party against said system user database to verify that said Non-identified Party has created a data record in said system user database, said computer system terminating the method should said computer system fail to locate said data record created by said Non-identified Party, thereupon said computer system electronically remitting a second failure message to said mobile phone belonging to said Identifying Party;
said computer system electronically remitting an Identifying Party verification message to said mobile phone belonging to said Identifying Party, said Identifying Party verification message optionally including an Identifying Party personal identification code extracted by said computer system from said Identifying Party's data record in said system user database, said Identifying Party personal identification code having been entered into said Identifying Party's data record in said system user database by said Identifying Party when said Identifying Party created said Identifying Party's data record;
said computer system electronically remitting a Non-identified Party verification message to said mobile phone belonging to said Non-identified Party, said Non-identified Party verification message optionally including a Non-identified Party personal identification number code extracted by said computer system from said Non-identified Party's data record in said system user database, said Non-identified Party personal identification code having been entered into said Non-identified Party's data record in said system user database by said Non-identified Party when said Non-identified Party created said Non-identified Party's data record;
said Identifying Party, upon receipt of said Identifying Party verification message, electronically remitting to said computer system an Identifying Party affirmation message if said Identifying Party personal identification code is correct, said Identifying Party affirmation message affirming the desire of said Identifying Party to identify said Non-identifying Party;
said Non-identified Party, upon receipt of said Non-identified Party verification message, electronically remitting to said computer system a Non-identified Party affirmation message if said Non-identified Party personal identification code is correct, said Non-identified Party affirmation message affirming the desire of said Non-identified Party to be identified by said Identifying Party;
said computer system receiving both said Identifying Party affirmation message and said Non-identified Party affirmation message, said computer system terminating the method at this step should said computer system fail to receive both said Identifying Party affirmation message and said Non-identified Party affirmation message, thereupon said computer system electronically remitting a third failure message to said mobile phone belonging to said Identifying Party and to said mobile phone belonging to said Non-identified Party;
said computer system electronically remitting an request for the identification data of said Non-identified Party to an identification database system administered by a government agency, said Non-identified Party having registered with said government agency and having submitted said identification data of said Non-identified Party to said identification database system, said identification data of said Non-identified Party comprising a digital image of said Non-identified Party, the date of birth of said Non-identified Party, and the name of said Non-identified Party;
said identification database system performing a search for said identification data of said Non-identified Party;
said identification database system, should said search for said identification data of said Non-identified Party fail to yield a data record for said Non-identified Party in said identification database system, electronically remitting a notice to said computer system, thereupon said computer system remitting to said Identifying Party and said Non-identified Party a fourth failure message that said computer system could not produce identification data pertaining to said Non-identified Party;
said identification database system, should said search for said identification data of said Non-identified Party yield a data record for said Non-identified Party in said identification database system, electronically remitting said identification data of said Non-identified Party to said computer system;
said computer system, upon receiving said identification data of said Non-identified Party from said identification database system, generating an electronic picture identification message of said Non-identified Party, said electronic picture identification message of said Non-identified Party including said identification data of said Non-identified Party, said electronic picture identification message of said Non-identified Party optionally including a warning if said Non-identified Party is below a certain age;
said computer system electronically remitting said electronic picture identification message of said Non-identified Party to said Identifying Party; and
said Identifying Party receiving said electronic picture identification message of said Non-identified Party on said mobile phone belonging to said Identifying Party, thereupon said Identifying Party viewing said electronic picture identification message of said Non-identified Party and using said electronic picture identification message of said Non-identified Party to verify the identity of said Non-identified Party.

2. The method of claim 1, where said identity request message is delivered to a specifically identified short message service short code, telephone number, or email address for branding purposes.

3. The method of claim 1, where said identity request message, Identifying Party verification message, Non-identified Party verification message, Identifying Party affirmation message, said first failure message, said second failure message, said third failure message, said fourth failure message and Non-identified Party affirmation message are electronic communications taking the form of: short message service (SMS) messages, phone calls to an interactive voice response (IVR) system, multimedia message service (MMS) messages, email messages, and electronic messages delivered using the wireless application protocol (WAP).

4. The method of claim 1, where said electronic picture identification message of said Non-identified Party is an electronic message delivered by the multimedia messaging service (MMS).

5. The method of claim 1, where said identity request message includes only said phone number associated with a mobile phone belonging to said Identifying Party, and the step of
said computer system, should said identity request message include said user identification name belonging to said Identifying Party but not said phone number associated with said mobile phone belonging to said Identifying Party, upon locating said data record created by said Identifying Party, retrieving said phone number associated with said mobile phone belonging to said Identifying Party from said data record created by said Identifying Party
is omitted, and the step of
said computer system processing said user identification name belonging to said Identifying Party or said phone number associated with said mobile phone belonging to said Identifying Party against said system user database to verify that said Identifying Party has created a data record in said system user database, said computer system terminating the method at this step should said computer system fail to locate said data record created by said Identifying Party, thereupon said computer system remitting a first failure message to said mobile phone belonging to said Non-identified Party
is omitted.

6. The method of claim 1, in which the step of
said computer system electronically remitting an Identifying Party verification message to said mobile phone belonging to said Identifying Party, said Identifying Party verification message optionally including an Identifying Party personal identification code extracted by said computer system from said Identifying Party's data record in said system user database, said Identifying Party personal identification code having been entered into said Identifying Party's data record in said system user database by said Identifying Party when said Identifying Party created said Identifying Party's data record
is omitted, and the step of
said computer system electronically remitting a Non-identified Party verification message to said mobile phone belonging to said Non-identified Party, said Non-identified Party verification message optionally including a Non-identified Party personal identification number code extracted by said computer system from said Non-identified Party's data record in said system user database, said Non-identified Party personal identification code having been entered into said Non-identified Party's data record in said system user database by said Non-identified Party when said Non-identified Party created said Non-identified Party's data record
is omitted, and the step of
said Identifying Party, upon receipt of said Identifying Party verification message, electronically remitting to said computer system an Identifying Party affirmation message if said Identifying Party personal identification code is correct, said Identifying Party affirmation message affirming the desire of said Identifying Party to identify said Non-identifying Party
is omitted, and the step of
said Non-identified Party, upon receipt of said Non-identified Party verification message, electronically remitting to said computer system a Non-identified Party affirmation message if said Non-identified Party personal identification code is correct, said Non-identified Party affirmation message affirming the desire of said Non-identified Party to be identified by said Identifying Party
is omitted, and the step of
said computer system receiving both said Identifying Party affirmation message and said Non-identified Party affirmation message, said computer system terminating the method at this step should said computer system fail to receive both said Identifying Party affirmation message and said Non-identified Party affirmation message, thereupon said computer system electronically remitting a third failure message to said mobile phone belonging to said Identifying Party and to said mobile phone belonging to said Non-identified Party
is omitted.

7. The method of claim 1, wherein said computer system is not administered by said Trusted Third Party, but is instead administered by said government agency administering said identification database system and optionally wherein a single information technology system comprises said computer system, said system user database and said identification database system.

8. The method of claim 1, wherein the step of
said computer system electronically remitting an request for the identification data of said Non-identified Party to an identification database system administered by a government agency, said Non-identified Party having registered with said government agency and having submitted said identification data of said Non-identified Party to said identification database system, said identification data of said Non-identified Party comprising a digital image of said Non-identified Party, the date of birth of said Non-identified Party, and the name of said Non-identified Party
is omitted, and replaced by the step of
said computer system electronically remitting an request for the identification data of said Non-identified Party to an identification database system administered by said Trusted Third Party, said identification data of said Non-identified Party comprising a digital image of said Non-identified Party, the date of birth of said Non-identified Party, and the name of said Non-identified Party, said Trusted Third Party either having received said identification data of said Non-identified Party from said Non-identified Party after having verified the identity of said Non-identified Party, or having received said identification data of said Non-identified Party from a government agency which has stored said identification data of said Non-identified Party.

9. A computer system functioning as the computer system of claim 1, said computer system comprising a plurality of computers, a plurality of servers a plurality of routers, a plurality of electronic communications devices and a database software application.

10. A method whereby a Non-identified Party may establish his or her identity to an Identifying Party, comprising the steps of:
said Identifying Party requesting that said Non-identified Party produce a form of picture identification;
said Non-identified Party remitting to said Identifying Party either a phone number associated with a mobile phone belonging to said Non-identified Party or a user identification name belonging to said Non-identified Party, said user identification name belonging to said Non-identified Party having been created by said Non-identified Party on a computer system administered by a Trusted Third Party;
said Identifying Party electronically remitting to said computer system an identity request message sent from a mobile phone belonging to said Identifying Party, said identity request message including either said phone number associated with a mobile phone belonging to said Non-identified Party or said user identification name belonging to said Non-identified Party, said Non-identified Party having created a Non-identified Party data record in a system user database administered by said computer system, said data record comprising personally identifiable information pertaining to said Non-identified Party;
said computer system receiving said identity request message;
said computer system extracting either said phone number associated with said mobile phone belonging to said Non-identified Party or said user identification name belonging to said Non-identified Party from said identity request message;
said computer system, should said identity request message include said user identification name belonging to said Non-identified Party but not said phone number associated with said mobile phone belonging to said Non-identified Party, upon locating said data record created by said Non-identified Party, retrieving said phone number associated with said mobile phone belonging to said Non-identified Party from said data record created by said Non-identified Party;
said computer system processing said user identification name belonging to said Non-identified Party or said phone number associated with said mobile phone belonging to said Non-identified Party against said system user database to verify that said Non-identified Party has created a data record in said system user database, said computer system terminating the method at this step should said computer system fail to locate said data record created by said Non-identified Party, thereupon said computer system remitting a first failure message to said mobile phone belonging to said Identifying Party;
said computer system extracting information identifying said mobile phone belonging to said Identifying Party from said identity request message, thereupon said computer system processing said extracted information identifying said mobile phone belonging to said Identifying Party against said system user database to verify that said Identifying Party has created a data record in said system user database, said computer system terminating the method should said computer system fail to locate said data record created by said Identifying Party, thereupon said computer system electronically remitting a second failure message to said mobile phone belonging to said Non-identifying Party;
said computer system electronically remitting an Identifying Party verification message to said mobile phone belonging to said Identifying Party, said Identifying Party verification message optionally including an Identifying Party personal identification code extracted by said computer system from said Identifying Party's data record in said system user database, said Identifying Party personal identification code having been entered into said Identifying Party's data record in said system user database by said Identifying Party when said Identifying Party created said Identifying Party's data record;
said computer system electronically remitting a Non-identified Party verification message to said mobile phone belonging to said Non-identified Party, said Non-identified Party verification message optionally including a Non-identified Party personal identification number code extracted by said computer system from said Non-identified Party's data record in said system user database, said Non-identified Party personal identification code having been entered into said Non-identified Party's data record in said system user database by said Non-identified Party when said Non-identified Party created said Non-identified Party's data record;
said Identifying Party, upon receipt of said Identifying Party verification message, electronically remitting to said computer system an Identifying Party affirmation message if said Identifying Party personal identification code is correct, said Identifying Party affirmation message affirming the desire of said Identifying Party to identify said Non-identifying Party;
said Non-identified Party, upon receipt of said Non-identified Party verification message, electronically remitting to said computer system a Non-identified Party affirmation message if said Non-identified Party personal identification code is correct, said Non-identified Party affirmation message affirming the desire of said Non-identified Party to be identified by said Identifying Party;
said computer system receiving both said Identifying Party affirmation message and said Non-identified Party affirmation message, said computer system terminating the method at this step should said computer system fail to receive both said Identifying Party affirmation message and said Non-identified Party affirmation message, thereupon said computer system electronically remitting a third failure message to said mobile phone belonging to said Identifying Party and to said mobile phone belonging to said Non-identified Party;
said computer system electronically remitting an request for the identification data of said Non-identified Party to an identification database system administered by a government agency, said Non-identified Party having registered with said government agency and having submitted said identification data of said Non-identified Party to said identification database system, said identification data of said Non-identified Party comprising a digital image of said Non-identified Party, the date of birth of said Non-identified Party, and the name of said Non-identified Party;
said identification database system performing a search for said identification data of said Non-identified Party;
said identification database system, should said search for said identification data of said Non-identified Party fail to yield a data record for said Non-identified Party in said identification database system, electronically remitting a notice to said computer system, thereupon said computer system remitting to said Identifying Party and said Non-identified Party a fourth failure message that said computer system could not produce identification data pertaining to said Non-identified Party;
said identification database system, should said search for said identification data of said Non-identified Party yield a data record for said Non-identified Party in said identification database system, electronically remitting said identification data of said Non-identified Party to said computer system;
said computer system, upon receiving said identification data of said Non-identified Party from said identification database system, generating an electronic picture identification message of said Non-identified Party, said electronic picture identification message of said Non-identified Party including said identification data of said Non-identified Party, said electronic picture identification message of said Non-identified Party optionally including a warning if said Non-identified Party is below a certain age;
said computer system electronically remitting said electronic picture identification message of said Non-identified Party to said Identifying Party; and
said Identifying Party receiving said electronic picture identification message of said Non-identified Party on said mobile phone belonging to said Identifying Party, thereupon said Identifying Party viewing said electronic picture identification message of said Non-identified Party and using said electronic picture identification message of said Non-identified Party to verify the identity of said Non-identified Party.

11. The method of claim 10, where said identity request message is delivered to a specifically identified short message service short code, telephone number, or email address for branding purposes.

12. The method of claim 10, where said identity request message, Identifying Party verification message, Non-identified Party verification message, Identifying Party affirmation message, said first failure message, said second failure message, said third failure message, said fourth failure message and Non-identified Party affirmation message are electronic communications taking the form of: short message service (SMS) messages, phone calls to an interactive voice response (IVR) system, multimedia message service (MMS) messages, email messages, and electronic messages delivered using the wireless application protocol (WAP).

13. The method of claim 10, where said electronic picture identification message of said Non-identified Party is an electronic message delivered by the multimedia messaging service (MMS).

14. The method of claim 10, where the step of
said computer system extracting information identifying said mobile phone belonging to said Identifying Party from said identity request message, thereupon said computer system processing said extracted information identifying said mobile phone belonging to said Identifying Party against said system user database to verify that said Identifying Party has created a data record in said system user database, said computer system terminating the method should said computer system fail to locate said data record created by said Identifying Party, thereupon said computer system electronically remitting a second failure message to said mobile phone belonging to said Non-identifying Party
is omitted.

15. The method of claim 10, in which the step of
said computer system electronically remitting an Identifying Party verification message to said mobile phone belonging to said Identifying Party, said Identifying Party verification message optionally including an Identifying Party personal identification code extracted by said computer system from said Identifying Party's data record in said system user database, said Identifying Party personal identification code having been entered into said Identifying Party's data record in said system user database by said Identifying Party when said Identifying Party created said Identifying Party's data record
is omitted, and the step of
said computer system electronically remitting a Non-identified Party verification message to said mobile phone belonging to said Non-identified Party, said Non-identified Party verification message optionally including a Non-identified Party personal identification number code extracted by said computer system from said Non-identified Party's data record in said system user database, said Non-identified Party personal identification code having been entered into said Non-identified Party's data record in said system user database by said Non-identified Party when said Non-identified Party created said Non-identified Party's data record
is omitted, and the step of
said Identifying Party, upon receipt of said Identifying Party verification message, electronically remitting to said computer system an Identifying Party affirmation message if said Identifying Party personal identification code is correct, said Identifying Party affirmation message affirming the desire of said Identifying Party to identify said Non-identifying Party
is omitted, and the step of
said Non-identified Party, upon receipt of said Non-identified Party verification message, electronically remitting to said computer system a Non-identified Party affirmation message if said Non-identified Party personal identification code is correct, said Non-identified Party affirmation message affirming the desire of said Non-identified Party to be identified by said Identifying Party
is omitted, and the step of
said computer system receiving both said Identifying Party affirmation message and said Non-identified Party affirmation message, said computer system terminating the method at this step should said computer system fail to receive both said Identifying Party affirmation message and said Non-identified Party affirmation message, thereupon said computer system electronically remitting a third failure message to said mobile phone belonging to said Identifying Party and to said mobile phone belonging to said Non-identified Party
is omitted.

16. The method of claim 10, wherein said computer system is not administered by said Trusted Third Party, but is instead administered by said government agency administering said identification database system and optionally wherein a single information technology system comprises said computer system, said system user database and said identification database system.

17. The method of claim 10, wherein the step of
said computer system electronically remitting an request for the identification data of said Non-identified Party to an identification database system administered by a government agency, said Non-identified Party having registered with said government agency and having submitted said identification data of said Non-identified Party to said identification database system, said identification data of said Non-identified Party comprising a digital image of said Non-identified Party, the date of birth of said Non-identified Party, and the name of said Non-identified Party
is omitted, and replaced by the step of
said computer system electronically remitting an request for the identification data of said Non-identified Party to an identification database system administered by said Trusted Third Party, said identification data of said Non-identified Party comprising a digital image of said Non-identified Party, the date of birth of said Non-identified Party, and the name of said Non-identified Party, said Trusted Third Party either having received said identification data of said Non-identified Party from said Non-identified Party after having verified the identity of said Non-identified Party, or having received said identification data of said Non-identified Party from a government agency which has stored said identification data of said Non-identified Party.

18. A computer system functioning as the computer system of claim 10, said computer system comprising a plurality of computers, a plurality of servers a plurality of routers, a plurality of electronic communications devices and a database software application.
